(19) United States
(12) Patent Application Publication
(10) Pub. No.: US 2009/0110246 A1
(43) Pub. Date: Apr. 30, 2009

(54) SYSTEM AND METHOD FOR FACIAL EXPRESSION CONTROL OF A USER INTERFACE

(76) Inventors: Stefan OLSSON, Lund (SE); Jonas Andersson, Lund (SE); Darius Katz, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/940,358

(22) Filed: Nov. 15, 2007

Related U.S. Application Data
(60) Provisional application No. 60/983,654, filed on Oct. 30, 2007.

(51) Int. Cl. G06K 9/00

(52) U.S. Cl. 382/118

(57) ABSTRACT

A mobile device obtains user input of message media for transmission to a remote device. The mobile device comprises a user interface including a display screen displaying information in accordance with a selected emotional indicator and an input device for obtaining the user input of the message media. A storage comprising a plurality of records, each associated with one of a plurality of predetermined emotional categories. A camera is directed towards the user for capturing an image of the user's face at a time proximate to user input of the message media. An emotional categorization module categorizes the image of the user's face to one of the plurality of predetermined emotional categories and selects the emotional indicator associated therewith as the selected emotional indicator.

### CROSS REFERENCE TO RELATED APPLICATION

This application claims priority under 35 U.S.C. §119 to U.S. Provisional Application No. 60/983,654, filed Oct. 30, 2007, the entire disclosure of which is incorporated herein by reference.

### TECHNICAL FIELD OF THE INVENTION

The present invention relates to automated systems for facial expression control of a user interface and, more particularly, to systems and methods for controlling the rendering of information on a user interface of a portable device in accordance with style parameters that are associated with a facial expression of the user.

### DESCRIPTION OF THE RELATED ART

Contemporary portable devices, including mobile telephones, portable data assistants (PDAs), and other mobile electronic devices typically include embedded email, text messaging (including Short Message Services (SMS) and/or Multimedia Messaging Services (MMS)), and other media communication applications—such as video telephony—in addition to traditional mobile telephony applications.

In many of these applications, such as the SMS and MMS text message applications, media input through a user interface of the portable device is both: i) rendered on a user interface of the mobile device and ii) transmitted for rendering on a user interface of the remote device. The media, particularly if text media, is typically viewed within a rendering environment that may be user controlled. The rendering environment may comprise environment parameters such as a display screen background color, a font color, a font style, and a frame border pattern.

A user typically configures his or her rendering environment for an application utilizing a key board or touch screen of the mobile device for selecting the environment parameters. Because the user interface of a mobile device is typically limited, configuration of a rendering environment for an application can be cumbersome. Further, after an application environment is configured, user's tend not to make modifications thereto because of the cumbersome effort required to manually reconfigure.

What is needed is an improved system and method for controlling the rendering environment for a media application that does not does not require cumbersome configuration utilizing the limited user interface common on portable devices. Further, what is needed is a system and method that determines and periodically modifies the configuration of a rendering environment based on factors determined about the user and, in particular, the user's facial expression.

### SUMMARY

A first aspect of the present invention comprises a mobile device for obtaining user input of message media for transmission to a remote device. Exemplary message media includes email, SMS text, MMS text, audio, and/or video.

The mobile device may comprise a user interface including an input device for obtaining the user input of the message media and a display screen for rendering of information, inclusive of the message media, in accordance with a selected emotional indicator.

A camera may be directed for capturing an image of the user's face at a time proximate to user input of the message media. The user image is provided to an emotional categorization module. The emotional categorization module categorizes the image of the user's face to one of the plurality of predetermined emotional categories and selects the emotional indicator associated therewith as the selected emotional indicator pursuant to which the information, including the message media, is rendered on the display screen.

A storage may associate, with each of the predetermined emotional categories, emotional indicators associated therewith. The emotional indicators may comprise one or more emoticons and/or a style sheet. The style may define a plurality of style parameters comprising at least one of: background color, font color, font style, and frame border.

The user image captured at a time proximate to user input of the media message may comprise an image captured when the user commencing input of the message media or at any time during user input of the message media. As such, in a sub-embodiment wherein the message media comprises a text message, for example email, SMS text, and/or MMS text, and the emotional indicator includes an emoticon, the image used categorizing the users emotion and selecting the emoticon may be an image captured when the user begins typing the text message or an image captured while the user is tying the text message—such as at the time the user enters a command to insert an emoticon.

In a sub-embodiment of this first aspect wherein the message media includes video, such video may be video captured by the camera and provided to both the emotional categorization module for determination of the selected emotional indicator and directly to the active messaging application as the message media.

In yet another sub-embodiment, the message media may be transmitted to the remote device in conjunction with the selected style whereby the remote device may drive display of the message media in accordance with the selected style on its user interface.

In yet anther sub-embodiment, at least one of the style sheets may include a cultural variation of at least one of the style parameters. In such embodiment, the emotional categorization module selects the cultural variation in accordance with user demographic data.

A second aspect of the present invention may comprise a mobile device for obtaining user input of a text message for transmission to a remote device. The mobile device of this second aspect may comprise a user interface that includes an input device for obtaining the user input of the text message and a display screen for rendering information inclusive of the text message.

A storage may comprise a plurality of emoticons, each of which may be uniquely associated with one of a plurality of predetermined emotional categories. A camera may be directed for capturing an image of the user's face at a time proximate to user input of the text message media. Again, the image of the user's face may be captured when the user begins typing the text message or while the user is tying the text message—such as at the time the user enters a command to insert an emoticon.

An emotional categorization module may categorize the image of the user's face to a selected one of the plurality of predetermined emotional categories and select the emoticon associated therewith for automated insertion into the text message.

A third aspect of the present invention may comprise a mobile device for obtaining user input of message media for transmission in association with a selected emotional indicator to a remote device. The mobile device of this third aspect may comprise a user interface that includes a display screen and an input device for obtaining the user input of the message media.

A storage may comprise a plurality of records, each of which is uniquely associated with one of a plurality of predetermined emotional categories. Each record may associate the emotional category with a plurality of style parameters. The style parameters may comprise at least one of: background color, font color, font style, and frame border.

A camera may be directed for capturing an image of the user's face at a time proximate to user input of the message media. An emotional categorization module may categorize the image of the user's face to one of the plurality of predetermined emotional categories and select at least one style associated therewith for transmission to the remote device as the selected emotional indicator.

A fourth aspect of the present invention may comprise a mobile device for obtaining user input of message media for transmission in association with a selected emotional indicator to a remote device. The mobile device may comprise a user interface including an input device for obtaining the user input of the message media.

A camera may be directed for capturing an image of the user's face at a time proximate to user input of the message media. An emotional categorization module may categorize the image of the user's face to one of the plurality of predetermined emotional categories and select an emotional indicator associated with the emotional category as the selected emotional indicator for transmission to the remote device.

In one sub-embodiment of this fourth aspect, the message media may comprise a text message such as email, SMS text message, or MMS text message. In such embodiment, a storage may associate an emoticon with each emotional category and the emotional categorization module may further insert into the text message, the emoticon associated with the selected emotional category.

In another sub-embodiment, each emotional category may further be uniquely associated with style parameters. The style parameters may comprise at least one of: background color, font color, font style, and frame border. The text media message may be displayed on a display screen of the device in accordance with the style parameters associated with the selected emotional category.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a diagram representing an exemplary mobile device implementing facial expression control of a user interface in accordance with one embodiment of the present invention;

FIG. 2 is a diagram representing exemplary style sheets in accordance with one embodiment of the present invention;

FIG. 3 is a diagram representing an exemplary mobile device implementing facial expression control of a user interface in accordance with another embodiment of the present invention; and

FIG. 4 is a diagram representing an exemplary mobile device implementing facial expression control of a user interface in accordance with yet another embodiment of the present invention.

### DETAILED DESCRIPTION OF EMBODIMENTS

The term “electronic equipment” as referred to herein includes portable radio communication equipment. The term “portable radio communication equipment”, also referred to herein as a “mobile radio terminal” or “mobile device”, includes all equipment such as mobile phones, pagers, communicators, e.g., electronic organizers, personal digital assistants (PDAs), smart phones or the like.

Many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

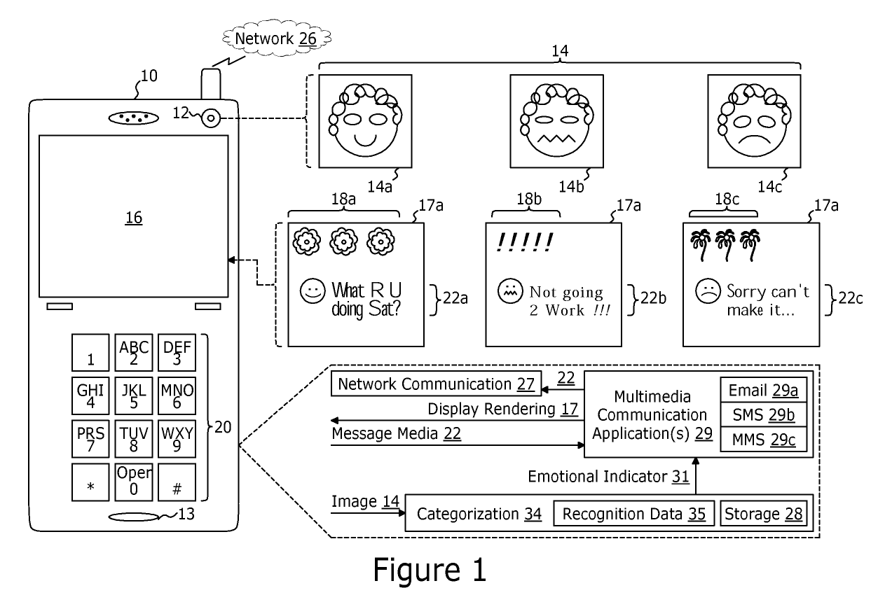

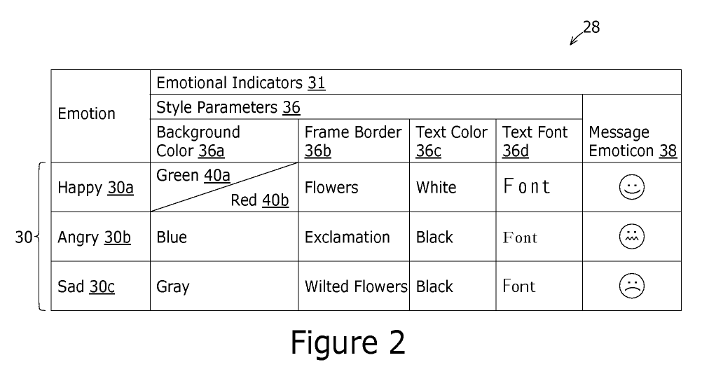

With reference to FIG. 1, an exemplary mobile device 10 is embodied in a mobile telephone, mobile PDA, or other mobile device which may include a network communication system 27 for communication with other devices over a wide area network 26 (FIG. 2) with which the network communication system 27 is compatible.

The mobile device 10 may further comprise a user interface comprising a display 16 for rendering of information and at least one input device. Exemplary input devices comprise a key board 20 for input of alpha numeric media, a microphone 13 for input of audio media, and/or a camera 12 for input of still or motion video media.

The mobile device 10 may further comprise one or more multimedia communication applications 29. The multimedia communication applications may comprise an email application 29a, a Simple Messaging Service (SMS) application 29b, and a Multimedia Messaging Services (MMS) application 29c which may include the ability to send video to a remote device.

When operating one of the multimedia communication applications 29, the input device (any of the keyboard 20, microphone 13, and/or camera 12) may be used for obtaining user input of message media 22. The message media 22 is input to the active multimedia communication application 29. In general, the active multimedia communication application 29 may provide the message media 22 to the network communication system 27 for transmission to a remote device. The active multimedia communication application 29 may further provide a display rendering 17 to drive a rendering of the message media 22 on the display screen 16.

The display rendering 17 may comprise a rendering of the message media 22 in accordance with a selected emotional indicators 31—which may include parameters such as background color, text color, text font, emoticons, and frame border patterns. As will be discussed in more detail, the selected emotional indicators 31 used for rendering of the media message 22 may be emotional indicators 31 which uniquely correspond to a detected emotion of the user—as determined by a user image 14 captured by the camera 12.

In more detail, and referring briefly to FIG. 2 in conjunction with FIG. 1, a storage 28 may comprise a plurality of records, each of which represents an emotional category 30. Exemplary emotional categories 30 include the emotional category of “happy” 30a, the emotional category of “angry” 30b, and the emotional category of “sad” 30c.

Each record may include a plurality of emotional indicators 31 such as style parameters 36 and a message emoticon 38. The style parameters 36 may be used to control the rendering of information on the display screen 16. Exemplary style parameters 36 comprise a background color 36a, a frame border 36b, a text color 36c, and a text font 36d.

As an example, for the emotional category of “happy” the style parameters 36 may comprise a background color 36a of “green”, a frame border 36b of “flowers”, a text color 36c of “white” a text font 36d that appears “happy” and a message emoticon 38 of a smiley face. As such, when the user's emotion is determined to be within the emotional category of “happy” 30a, the display rendering (as represented by rendering 17a) comprises a rendering of text message media 22a with a green background color (not represented), a frame border 18a comprising flowers, a white text color (not represented), the text font that appears “happy”, and with a smiley face emoticon.

As another example, for the emotional category of “angry” the style parameters 36 may comprise a background color 36a of “blue”, a frame border 36b of “exclamation points”, a text color 36c of “black”, a text font that appears “angry” and a message emoticon 38 of an angry face. As such, when the user's emotion is determined to be within the emotional category of “angry” 30b, the display rendering (as represented by rendering 17b) comprises a rendering of text message media 22b with a blue background color (not represented), a frame border 18b comprising exclamation points, a black text color, the text font that appears “angry”, and with an angry face emoticon.

As another example, for the emotional category of “sad” the style parameters 36 may comprise a drab background color 36a of “gray”, a frame border 36b of “wilted flowers”, a text color 36c of “black”, a text font that appears “sad” and a message emoticon 38 of a sad frowning face. As such, when the user's emotion is determined to be within the emotional category of “sad” 30c, the display rendering (as represented by rendering 17c) comprises a rendering of text message media 22c with a gray background color (not represented), a frame border 18c comprising wilted flowers, a black text color, the text font that appears “sad”, and with a sad face emoticon.

In operation, the camera 12 of the mobile device 10 may be directed towards the face of the user at a time proximate to when the user is inputting the message media 22. An emotional categorization module 34 obtains a digital user image 14 from the camera 12 and may compare features of the digital user image 14 to recognition data 35 for purposes of categorizing the digital user image 14 (e.g. the emotion displayed by the user's face) into one of the plurality of predetermined emotional categories 30.

Once the categorization module 34 determines the user's emotional category 30, the emotional indicators 31 associated therewith are selected as the selected emotional indicators. As such, the style parameters 36 associated therewith are utilized for the display rendering 17 and, if the message media 22 is text message media, the emoticon 38 associated therewith may be automatically inserted into the text message media 22.

For example, user digital image 14a may include image features such as upwardly turned lips (e.g. a smile) which, when compared with recognition data 35, indicate the user's “happy” emotion and, in accordance therewith, the categorization module selects the emotional category of “happy” 30a for the display rendering as represented by 17a.

Similarly, user digital image 14b may include image features such as a wrinkled brow and/or a horizontal lip posture which, when compared with recognition data 35, indicates the user's “angry” emotion and, in accordance therewith, the categorization module selects the emotional category of “angry” 30b for the display rendering as represented by 17b.

User digital image 14c may include image features such as a droopy eyes and wilted facial muscles which, when compared with recognition data 35, indicates the user's “sad” emotion and, in accordance therewith, the categorization module selects the emotional category of “sad” 30c for the display rendering as represented by 17c.

Turning briefly to FIG. 2, it is envisioned that different style parameters 36 may have different emotional significance in different cultures. As such, at least one style parameters 36, in at least one emotional category 30, for example the style parameter of “background color” 36a and the emotional category of “happy” 30a may include a cultural variation. The cultural variation may, for example, be a background color which, for example, is “green” 40a for western cultures and “red” 40b for Asian cultures. The selection of a cultural variation for use in rendering of media content 22 on the display 16 (and/or transmitted as an emotional indicator 31 to a remote device) may be based on user demographic data determined by any of: i) data input by the user; ii) data provided by the mobile telephony service provider; or iii) data automatically detected based on the location of the mobile device 10.

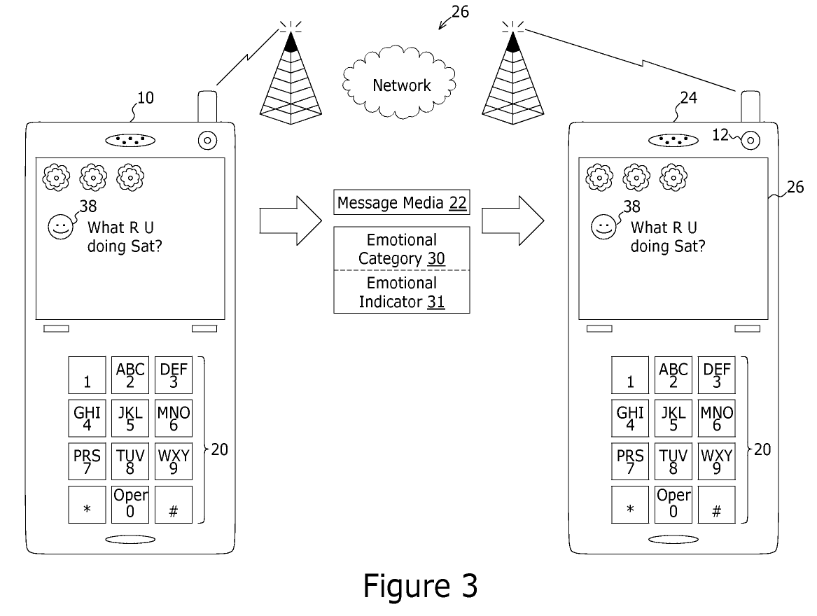

Turning to FIG. 3, in an additional embodiment of the present invention, it is envisioned that the message media 22 is transmitted to a remote device 24 in conjunction with: i) identification of the user's emotional category 30; and/or ii) at least one selected emotional indicator 31.

In the embodiment where the message media 22 is transferred in conjunction with at least one selected emotional indicator 31, such as style parameters 36, a rendering 26 on the display of the remote device 24 may be in accordance with the style parameters 36 (FIG. 2). If the selected emotional indicator 31 includes an emoticon 38, it may be included in the rendering 26 on the display of the remote device 24.

In the embodiment where the message media 22 is transferred in conjunction with identification of the user's emotional category 30, a rendering 26 on the display of the remote device 24 may be in accordance with a locally stored style emotional indicators (e.g. stored on the remote device 24) which corresponds with the identified emotional category of the user.

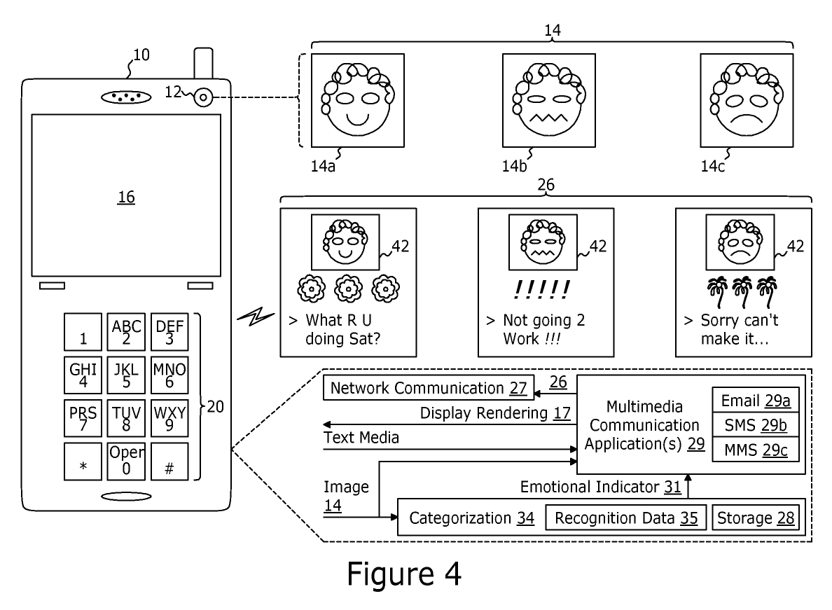

Turning to FIG. 4, an embodiment of the present invention is represented wherein the message media 22 further comprises the still or motion video image 14 captured by the camera 12 within a frame 42 within a message rendering 26. The message rendering 26 may be included in the display rendering 17 on display screen 16 of the device 10 as well as being transferred to the remote device by the network communication system 27. In this embodiment, the image 14 may not only be used by the categorization module 34 for determining the selected emotional indicator 31 but may also comprise at least a portion of the message media 22 that is transferred to the remote device (and rendered in accordance with the selected emotional indicator 31). Further, in this embodiment, it is envisioned that the categorization module 34 may continually monitor the video image 14 and update the selected emotional indicator as the user's emotions change.

Although the invention has been shown and described with respect to certain preferred embodiments, it is obvious that equivalents and modifications will occur to others skilled in the art upon the reading and understanding of the specification. For example, although background color, text color, text font and frame border are exemplary style parameters, it is envisioned that other parameters controlling the look and feel of the user interface of a mobile device may be appropriate style parameters. The present invention includes all such equivalents and modifications, and is limited only by the scope of the following claims.

1. A mobile device for obtaining user input of message media for transmission in association with a selected emotional indicator to a remote device, the mobile device comprising:
a user interface comprising an input device for obtaining the user input of the message media;
a camera directed for capturing an image of the user's face at a time proximate to user input of the message media;
an emotional categorization module categorizing the image of the user's face to one of the plurality of predetermined emotional categories and selecting an emotional indicator associated with the predetermined emotional category as the selected emotional indicator for transmission to the remote device.

2. The mobile device of claim 1, wherein:
the message media comprises a text message; and
the selected emotional indicator comprises an emoticon; and
the emotional categorization module further inserts into the text message, the emoticon.

3. The mobile device of claim 1, wherein:
the selected emotional indicator comprises at least one style parameter whereby the remote device may drive display of the message media in accordance with the style parameter.

4. The mobile device of claim 3, wherein the style parameter comprises at least one of: background color, font color, font style, and frame border.

5. The mobile device of claim 4, wherein the style parameter includes at least two cultural variations; and
the emotional categorization module further determines, in accordance with user demographic data, a selected cultural variation for transmission to the remote device.

6. The mobile device of claim 3, wherein:
the message media comprises a text message; and
the selected emotional indicator further comprises an emoticon; and
the emotional categorization module further inserts into the text message, the emoticon.

7. The mobile device of claim 1, wherein:
the selected emotional indicator comprises at least one style parameter whereby the remote device may drive display of the message media in accordance with the style parameter; and
the user interface further comprises a display screen displaying the message media in accordance with the style parameter.

8. The mobile device of claim 7, wherein the style parameter comprises at least one of: background color, font color, font style, and frame border.

9. The mobile device of claim 8, wherein the style parameter includes at least two cultural variations; and
the emotional categorization module further determines, in accordance with user demographic data, a selected cultural variation for transmission to the remote device.

10. The mobile device of claim 7, wherein:
the message media comprises a text message; and
the selected emotional indicator further comprises an emoticon; and
the emotional categorization module further inserts into the text message, the emoticon.

11. A mobile device for obtaining user input of message media for transmission to a remote device, the mobile device comprising:
a user interface comprising a display screen displaying information in accordance with a selected emotional indicator an input device for obtaining the user input of the message media;
a camera directed for capturing an image of the user's face at a time proximate to user input of the message media;
an emotional categorization module categorizing the image of the user's face to one of the plurality of predetermined emotional category and selecting an emotional indicator associated with the predetermined emotional category as the selected emotional indicator.

12. The mobile device of claim 11, wherein:
the message media comprises a text message; and
the selected emotional indicator comprises an emoticon; and
the emotional categorization module further inserts into the text message, the emoticon.

13. The mobile device of claim 11, wherein:
the selected emotional indicator comprises at least one style parameter; and
the display screen displays information in accordance with the style parameter.

14. The mobile device of claim 13, wherein the style parameter comprises at least one of: background color, font color, font style, and frame border.

15. The mobile device of claim 13, wherein the style parameter includes at least two cultural variations; and
the emotional categorization module further determines, in accordance with user demographic data, a selected cultural variation for control of rendering information on the display screen.

16. The mobile device of claim 13, wherein:
the message media comprises a text message; and
the selected emotional indicator further comprises an emoticon; and
the emotional categorization module further inserts into the text message, the emoticon.

17. The mobile device of claim 11, wherein the selected emotional indicator is transferred to the remote device in conjunction with the message media.

18. The mobile device of claim 17, wherein:
the message media comprises a text message; and
the selected emotional indicator comprises an emoticon; and
the emotional categorization module further inserts into the text message, the emoticon.

19. The mobile device of claim 11, wherein:
the selected emotional indicator comprises at least one style parameter; and
the display screen displays information in accordance with the style parameter.

20. The mobile device of claim 19, wherein the style parameter comprises at least one of: background color, font color, font style, and frame border.
